(19) United States
(12) Patent Application Publication
(10) Pub. No.: US 2022/0264493 A1
(43) Pub. Date: Aug. 18, 2022

(54) TERMINAL

(71) Applicant: NTT DOCOMO, INC., Tokyo (JP)

(72) Inventors: Hiroki Harada, Tokyo (JP); Satoshi Nagata, Tokyo (JP); Jing Wang, Beijing (CN); Xiaolin Hou, Beijing (CN)

(73) Assignee: NTT DOCOMO, INC., Tokyo (JP)

(21) Appl. No.: 17/625,603

(22) PCT Filed: Jul. 12, 2019
(86) PCT No.: PCT/JP2019/027817

§ 371 Date: Jan. 7, 2022

(51) Int. Cl. H04W 56/00; H04W 74/08

(52) U.S. Cl. CPC H04W 56/001; H04W 74/0833

(57) ABSTRACT

A terminal receives a synchronization signal block (SSB) in a different frequency band different from the frequency band that includes one or a plurality of frequency ranges, and based on the synchronization signal block, determines a transmission opportunity of a preamble via a random access channel based on the synchronization signal block. The terminal receives the synchronization signal block with an expanded index range determines the transmission opportunity of the preamble via the random access channel based on i mod M where i is a synchronization signal block index and M is number of synchronization signal blocks.

### TECHNICAL FIELD

The present invention relates to a terminal that performs radio communication and particularly, relates to a terminal that receives synchronization signal block (SSB).

### BACKGROUND ART

The 3rd Generation Partnership Project (3GPP) specifies Long Term Evolution (LTE), and with the aim of further speeding, specifies LTE-Advanced (hereinbelow, the LTE includes the LTE-Advanced). In the 3GPP, specifications for 5th generation mobile communication system (5G, also called as New Radio (NR) or Next Generation (NG)) are also being considered.

In Release 15 and Release 16 (NR) of the 3GPP, the operation of the bands including FR1 (410 MHz to 7.125 GHz) and FR2 (24.25 GHz to 52.6 GHz) is specified. In addition, in the specifications after Release 16, operation in a band exceeding 52.6 GHz has been studied (Non-Patent Document 1). The target frequency range in Study Item (SI) is 52.6 GHz to 114.25 GHz.

When the carrier frequency is very high, an increase in phase noise and propagation loss becomes a problem. It is also more sensitive to peak-to-average power ratio (PAPR) and power amplifier nonlinearity.

In the NR, the measurement of initial access, cell detection, and reception quality are performed by using SSB (SS/PBCH Block) composed of synchronization signal (SS: Synchronization Signal) and downlink physical broadcast channel (PBCH: Physical Broadcast Channel) (Non-Patent Document 2). A transmission cycle of the SSB can be set for each cell in the range of 5, 10, 20, 40, 80, 160 milliseconds (assuming initial access terminal (User Equipment, UE) has a transmission cycle of 20 milliseconds).

The transmission of the SSB within the transmission cycle time is limited to within 5 milliseconds (half frame) and each SSB can be associated with a different beam. In Release 15, the number of SSB indexes is 64 (0 to 63 indexes).

SSB index is mapped with a random access (PA) procedure opportunity, specifically, a random access channel (PRACH: Physical Random Access Channel) opportunity (PRACH Occasion (RO)) (Non-Patent Document 3).

### PRIOR ART DOCUMENT

### Non-Patent Document

Non-Patent Document 1: 3GPP TR 38.807 V0.1.0, 3rd Generation Partnership Project; Technical Specification Group Radio Access Network; Study on requirements for NR beyond 52.6 GHz (Release 16), 3GPP, March 2019
Non-Patent Document 2: 3GPP TS 38.133 V15.5.0, 3rd Generation Partnership Project; Technical Specification Group Radio Access Network; NR; Requirements for support of radio resource management (Release 15), 3GPP, March 2019
Non-Patent Document 3: 3GPP TS 38.213 V15.5.0, 3rd Generation Partnership Project; Technical Specification Group Radio Access Network; NR; Physical layer procedures for control (Release 15), 3GPP, March 2019

### SUMMARY OF THE INVENTION

When using a different frequency band different from FR1/FR2, such as the above high frequency band exceeding 52.6 GHz, in order to cope with a wide bandwidth and a large propagation loss, it is necessary to generate a narrower beam by using a large (massive) antenna having a large number of antenna elements. That is, a large number of beams are required to cover a certain geographical area.

Therefore, one approach is to further increase the number of SSBs in order to support a large number of beams. In order to suppress overhead related to SSB signaling and reduce data scheduling delay, SSB detection/measurement time and power consumption, one option is to simultaneously transmit, from the network to the terminal using the same time position or the same frequency position, a plurality of SSBs having different pseudo-colocation (QCL: Quasi Co-Location) assumptions.

However, in Release 15, the mapping from SSB to PRACH Occasion (RO) is prescribed by specific parameters, specifically “ssb-perRACH-Occasion” (see 3GPP TS38.331), and msg1-FDM, N_{preamble}\hat{ }total (see 3GPP TS38.213), how to map RO becomes an issue when multiple SSBs with different QCL assumptions are sent at the same time.

The present invention has been made in view of the above discussion. One object of the present invention is to provide a terminal capable of correctly recognizing a transmission opportunity (PRACH Occasion (RO)) of a random access (RA) procedure mapped to the SSB even when the SSB setting such as the number of SSBs used is expanded.

According to one aspect of the present disclosure a terminal (UE 200) includes a receiving unit (radio signal transmitting and receiving unit 210) that receives a synchronization signal block (SSB) in a different frequency band (e.g., FR4) different from a certain frequency band that includes one or a plurality of frequency ranges (FR1, FR2); and a control unit (control unit 270) that determines a transmission opportunity of a preamble (PRACH Occasion (RO)) via a random access channel based on the synchronization signal block. The receiving unit receives the synchronization signal block in which a range of an index of the synchronization signal block (SSB index) is expanded as compared with the case of using the certain frequency band, and the control unit determines the transmission opportunity of the preamble based on the synchronization signal block with the index expanded.

According to another aspect of the present disclosure a terminal (UE 200) includes a receiving unit (radio signal transmitting and receiving unit 210) that receives a synchronization signal block (SSB) in a different frequency band (e.g., FR4) different from a certain frequency band that includes one or a plurality of frequency ranges (FR1, FR2); and a control unit (control unit 270) that determines a transmission opportunity of a preamble (PRACH Occasion (RO)) via a random access channel based on the synchronization signal block. The receiving unit receives the synchronization signal block in which a range of an index of the synchronization signal block is expanded as compared with the case of using the certain frequency band, and the control unit determines the transmission opportunity of the preamble via the random access channel based on i mod M, where i is an index of the synchronization signal block and M is number of the synchronization signal blocks.

According to still another aspect of the present disclosure a terminal (UE 200) includes a receiving unit (radio signal transmitting and receiving unit 210) that receives a synchronization signal block (SSB) in a different frequency band (e.g., FR4) different from a certain frequency band that includes one or a plurality of frequency ranges (FR1, FR2); and a control unit (control unit 270) that determines a transmission opportunity of a preamble (PRACH Occasion (RO)) via a random access channel based on the synchronization signal block. The receiving unit receives the synchronization signal block in which a range of an index of the synchronization signal block is expanded as compared with the case of using the certain frequency band, and the control unit determines to increase or decrease the transmission opportunity of the preamble that is frequency division multiplexed.

### BRIEF DESCRIPTION OF DRAWINGS

FIG. 1 is an overall schematic configuration diagram of a radio communication system 10.

FIG. 2 is a diagram showing a frequency range used in the radio communication system 10.

FIG. 3 is a diagram illustrating a configuration example of a radio frame, a subframes, and slots used in the radio communication system 10.

FIG. 4 is a diagram illustrating a configuration example of SSB burst.

FIG. 5 is a diagram illustrating a partial arrangement example of SSBs when the number of SSBs is expanded to a value exceeding 64.

FIG. 6 is a diagram illustrating a configuration example of a synchronization signal block (SSB).

FIG. 7 is an explanatory diagram of a relationship, on a radio frame, between an example of allocation of the SSB and a beam BM.

FIG. 8A is a diagram showing a sequence example (4-step RA) of a random access (RA) procedure.

FIG. 8B is a diagram showing a sequence example (2-step RA) of a random access (RA) procedure.

FIG. 9A is a diagram showing a conventional mapping example (part 1) between PRACH Occasion (RO) and SSB index.

FIG. 9B is a diagram showing a conventional mapping example (part 2) between PRACH Occasion (RO) and SSB index.

FIG. 10 is a functional block diagram of UE 200.

FIG. 11 is a diagram illustrating a configuration example of SSB burst when 256 SSBs are transmitted sequentially and not simultaneously.

FIG. 12 is a diagram illustrating a configuration example of SSB burst in the case where a plurality of SSBs is simultaneously transmitted according to Operation Example 1.

FIG. 13 is a diagram illustrating another configuration example of the SSB burst in the case where a plurality of SSBs is simultaneously transmitted according to Operation Example 1.

FIG. 14 is a diagram showing an example of mapping between SSB and RO in Operation Example 2-1.

FIG. 15 is a diagram showing an example of mapping between SSB and RO in Operation Example 2-2.

FIG. 16 is a diagram showing a concept of transmission/reception of a beam BM by a gNB 100 in Operation Example 2-2.

FIG. 17 is a diagram illustrating a mapping example (part 1) between SSB and RO in Operation Example 2-3.

FIG. 18 is a diagram showing an example (part 2) of mapping between SSB and RO in Operation Example 2-3.

FIG. 19 is a diagram showing a mapping example (part 1) between SSB and RO in Operation Example 2-4.

FIG. 20 is a diagram showing a mapping example (part 2) between SSB and RO in Operation Example 2-4.

FIG. 21 is a diagram illustrating an example of a hardware configuration of UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) OVERALL SCHEMATIC CONFIGURATION OF RADIO COMMUNICATION SYSTEM

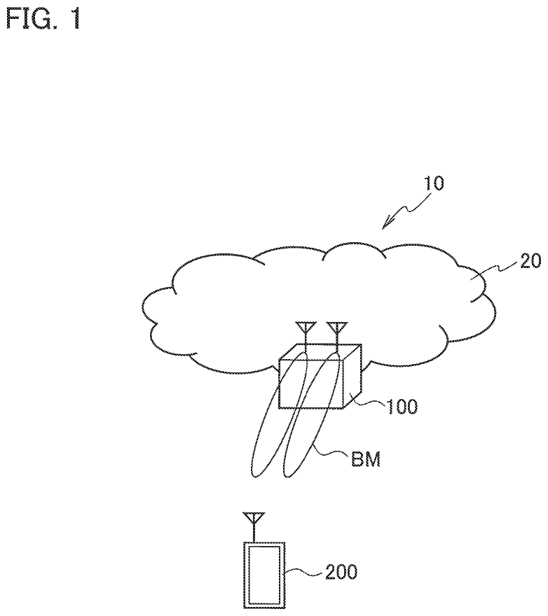

FIG. 1 is an overall schematic configuration diagram of a radio communication system 10 according to the present embodiment. The radio communication system 10 is a radio communication system according to 5G New Radio (NR). The radio communication system 10 includes Next Generation-Radio Access Network 20 (hereinafter, “NG-RAN 20”) and a terminal 200 (hereinafter, “UE 200”).

The NG-RAN 20 includes a radio base station 100 (hereinafter, “gNB 100”). A concrete configuration of the radio communication system 10, including the number of the gNBs and the UEs, is not limited to the example shown in FIG. 1.

The NG-RAN 20 actually includes a plurality of NG-RAN Nodes, in particular, the gNBs (or ng-eNB). Also, the NG-RAN 20 is connected to a core network (5GC, not shown) according to the 5G. The NG-RAN 20 and the 5GC may be simply expressed as “network”.

The gNB 100 is a radio base station according to the 5G. The gNB 100 performs a radio communication with the UE 200 according to the 5G. The gNB 100 and the UE 200 can handle, by controlling a radio signal transmitted from a plurality of antenna elements, Massive MIMO (Multiple-Input Multiple-Output) that generates a beam BM with a higher directivity, carrier aggregation (CA) that bundles a plurality of component carriers (CC) to use, dual connectivity (DC) in which communication is performed simultaneously between two NG-RAN Nodes and the UE, and the like.

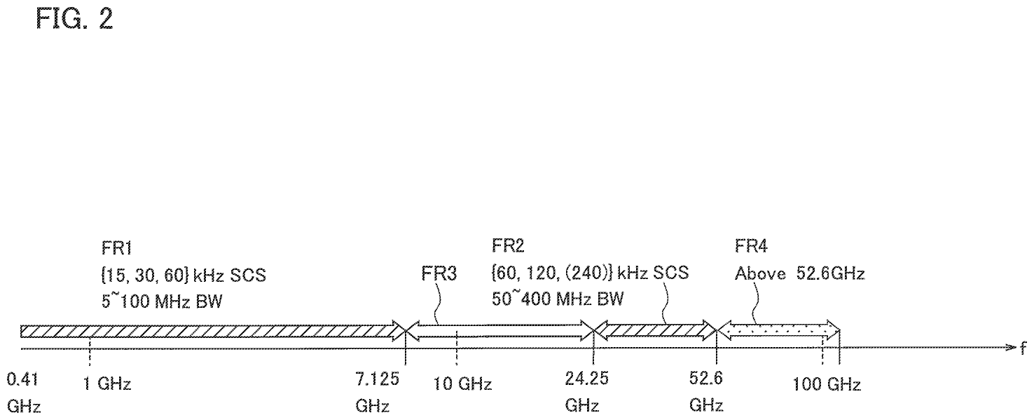

The radio communication system 10 corresponds to a plurality of frequency ranges (FR). FIG. 2 shows the frequency range used in the radio communication system 10.

As shown in FIG. 2, the radio communication system 10 corresponds to FR1 and FR2. The frequency band of each FR is as below.
FR1: 410 MHz to 7.125 GHz
FR2: 24.25 GHz to 52.6 GHz

In FR1, 15 kHz, 30 kHz, or 60 kHz Sub-Carrier Spacing (SCS) is used, and a bandwidth (BW) of 5 MHz to 100 MHz is used. FR2 has a higher frequency than FR1. Moreover, FR2 uses SCS of 60 kHz or 120 kHz (240 kHz may be included), and uses a bandwidth (BW) of 50 MHz to 400 MHz.

Note that SCS may be interpreted as numerology. The numerology is defined in 3GPP TS38.300 and corresponds to one subcarrier spacing in the frequency domain.

Furthermore, the radio communication system 10 can handle to a frequency band that is higher than the frequency band of FR2. Specifically, the radio communication system 10 can handle a frequency band exceeding 52.6 GHz and up to 114.25 GHz. Here, such a high frequency band is referred to as “FR4” for convenience. FR4 belongs to so-called EHF (extremely high frequency, also called millimeter wave). FR4 is a temporary name and may be called by another name.

FR4 may be further classified. For example, FR4 may be divided into a frequency range of 70 GHz or less and a frequency range of 70 GHz or more. Alternatively, FR4 may be divided into more frequency ranges, and may be divided in frequencies other than 70 GHz.

Here, the frequency band between FR1 and FR2 is referred to as “FR3” for convenience. FR3 is a frequency band above 7.125 GHz and below 24.25 GHz.

In the present embodiment, FR3 and FR4 are different from the frequency band including FR1 and FR2, and are called different frequency bands.

Particularly, as described above, in a high frequency band such as FR4, an increase in phase noise between carriers becomes a problem. This may require application of a larger (wider) SCS or a single carrier waveform.

Also, a narrower beam (i.e., a larger number of beams) may be required due to increased propagation loss. In addition, since it is more sensitive to PAPR and power amplifier nonlinearity, a greater (wider) SCS (and/or fewer FFT points), a PAPR reduction mechanism, or a single carrier waveform may be required.

In order to address these issues, in this embodiment, when using a band exceeding 52.6 GHz, Cyclic Prefix-Orthogonal Frequency Division Multiplexing (CP-OFDM)/Discrete Fourier Transform-Spread (DFT-S-OFDM) having a larger Sub-Carrier Spacing (SCS) can be applied.

However, the larger the SCS, the shorter the symbol/Cyclic Prefix (CP) period and the slot period (when the 14 symbol/slot configuration is maintained).

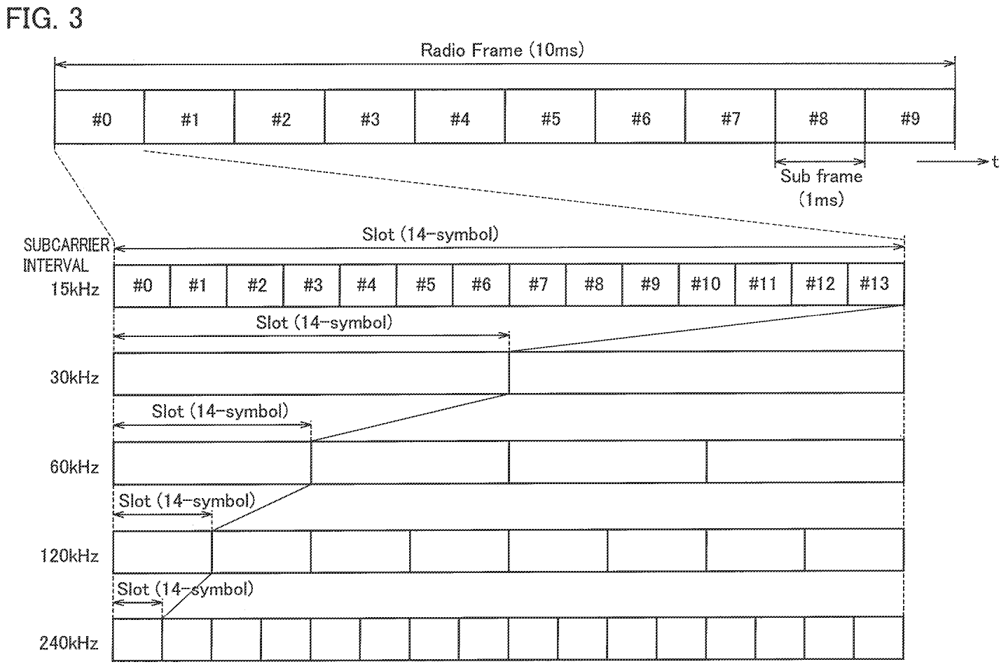

FIG. 3 shows a configuration example of a radio frame, subframes, and slots used in the radio communication system 10. Table 1 shows the relationship between the SCS and the symbol period.

TABLE 1

| SCS | 15 kHz | 30 kHz | 60 kHz | 120 kHz | 240 kHz | 480 kHz | 960 kHz |
|---|---|---|---|---|---|---|---|
| Symbol Period | 66.6 | 33.3 | 16.65 | 8.325 | 4.1625 | 2.08125 | 1.040625 |
| (Unit: μs) | | | | | | | |

As shown in Table 1, when the 14 symbol/slot configuration is maintained, the symbol period (and slot period) becomes shorter as the SCS becomes larger (wider). The SS/PBCH Block (SSB) time domain period is also shortened.

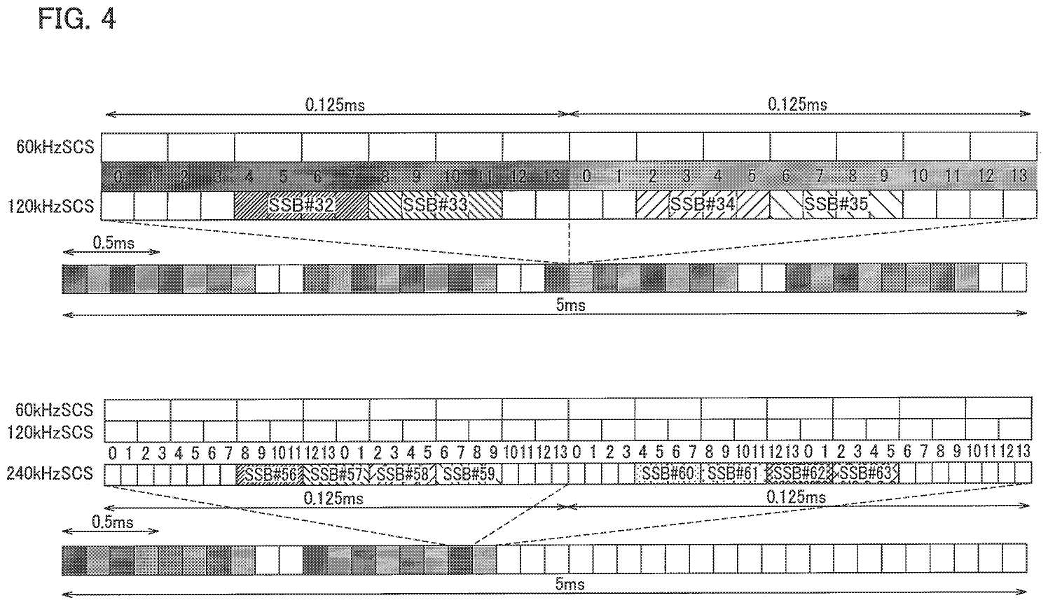

FIG. 4 shows a configuration example of SSB burst. The SSB is a block of a synchronization signal/broadcast channel composed of Synchronization Signal (SS) and PBCH (Physical Broadcast CHannel). Mainly, UE 200 is periodically transmitted to perform cell ID and reception timing detection at the start of communication. In 5G, the SSB is also used to measure a reception quality of each cell.

In the case of Release 15, the following contents are defined regarding SSB setting of a serving cell. Specifically, 5, 10, 20, 40, 80, and 160 milliseconds are defined as the transmission period (periodicity) of the SSB. Note that, the UE 200 for initial access is assumed to have a transmission period of 20 milliseconds.

The network (NG-RAN20) notifies the UE 200 of SSB index indication (ssb-PositionsInBurst) actually transmitted to the UE 200 through system information (SIB1) or signaling in a radio resource control layer (RRC).

Specifically, in the case of FR1, the same is notified by 8-bit bitmap of RRC and SIB1. Further, in the case of FR2, it is notified by RRC 64-bit bitmap, SSB 8-bit bitmap in the SIB1 group, and the SIB1 8-bit group bitmap.

In addition, as explained above, when dealing with FR4 (high frequency band) and the like, in order to address the issue of the wide bandwidth and large propagation loss, it is necessary to generate a narrow beam by using a large antenna with many antenna elements. That is, a large number of beams are required to cover a certain geographical area.

In case of Release 15 (FR2), the maximum number of beams used for SSB transmission is 64; however, it is preferable to expand the maximum number of beams (e.g., 256) to cover a certain geographical area with a narrow beam.

Therefore, in the present embodiment, the maximum number of beams used for SSB transmission is expanded to 256. For this reason, the number of SSBs is 256, and an index (SSB index) for identifying SSBs is a value after #64.

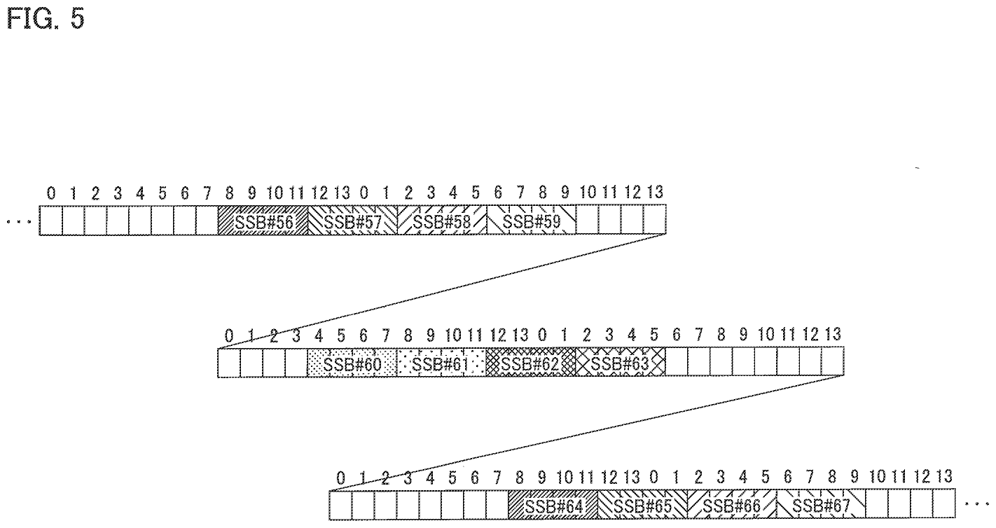

FIG. 5 shows a partial arrangement example of SSBs when the number of SSBs is expanded to a value exceeding 64. Specifically, FIG. 5 shows a state in which SSBs having an SSB index of #64 or later are added to the configuration example of the SSB burst shown in FIG. 4. Note that when a larger SCS is applied, as shown in Table 1, the symbol periods may be different.

As shown in FIG. 5, the SSB index can have a value after #64. In the present embodiment, an explanation has been given below assuming that the SSB index range is 0 to 255. However, the value of the SSB index and the range of the SSB index are not particularly limited to that mentioned here. That is, the number of SSBs may exceed 256, may exceed 64 and may be less than 256.

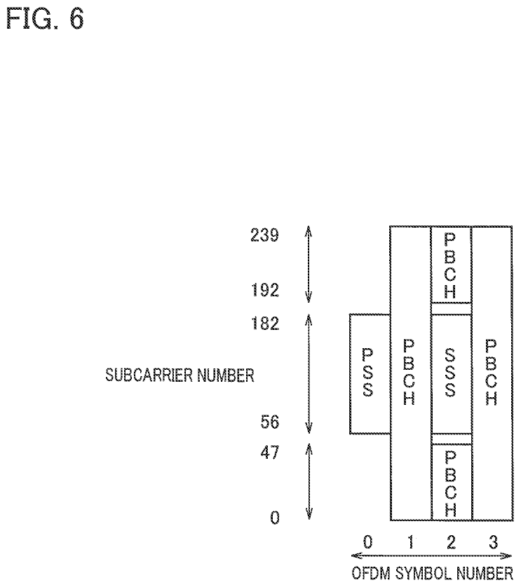

FIG. 6 shows a configuration example of the synchronization signal block (SSB). As shown in FIG. 6, the SSB is composed of a synchronization signal (SS) and a downlink physical broadcast channel (PBCH).

The SS is composed of a primary synchronization signal (PSS: Primary SS) and a secondary synchronization signal (SSS: Secondary SS).

PSS is a known signal that UE 200 first tries to detect in a cell search procedure. SSS is a known signal transmitted to detect a physical cell ID in the cell search procedure.

PBCH includes a radio frame number (SFN: System Frame Number) and an index and the like for identifying a symbol position of multiple SS/PBCH blocks in a half frame (5 milliseconds) that is the information required by the UE 200 when establishing frame synchronization with the NR cell formed by the gNB 100 after detection of SS/PBCH block.

The PBCH can also include system parameters necessary for receiving the system information (SIB). Further, the SSB includes a broadcast channel demodulation reference signal (DMRS for PBCH). DMRS for PBCH is a known signal transmitted to measure the radio channel state for PBCH demodulation.

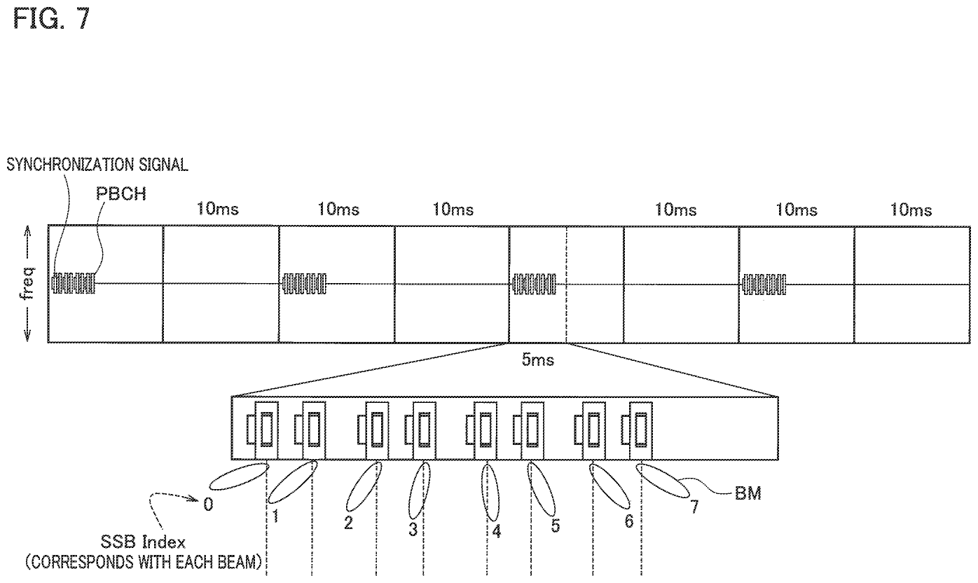

FIG. 7 is an explanatory diagram showing a relationship between SSB allocation and a beam BM on a radio frame. As explained above, SSB, specifically, the synchronization signal (PSS/SSS) and PBCH shown in FIG. 6, is transmitted in either the first half or the second half of each radio frame (5 milliseconds) (FIG. 7 shows an example of transmission in the first half frame). Also, the terminal assumes that each SSB is associated with a different beam BM. That is, the terminal assumes that each SSB is associated with a beam BM having a different transmission direction (coverage). Thereby, the UE 200 residing in the NR cell can receive one of the beams BM, acquire the SSB, and start the initial access and SSB detection/measurement.

Note that SSB transmission patterns vary depending on SCS, frequency range (FR), or other parameters. Also, not all the SSBs need to be transmitted. That is, depending on network requirements and conditions, only a small number of SSBs can be selectively transmitted, and which SSBs are transmitted and which SSBs are not transmitted can be notified to the UE 200.

The transmission pattern of SSB is notified to UE 200 by the RRC Information Element (IE) called ssb-PositionsInBurst described above.

The UE 200 is provided with a transmission opportunity (referred to as PRACH Occasion (RO)) of one or more PRACHs (Physical Random Access Channels) associated with SSB (SS/PBCH Block).

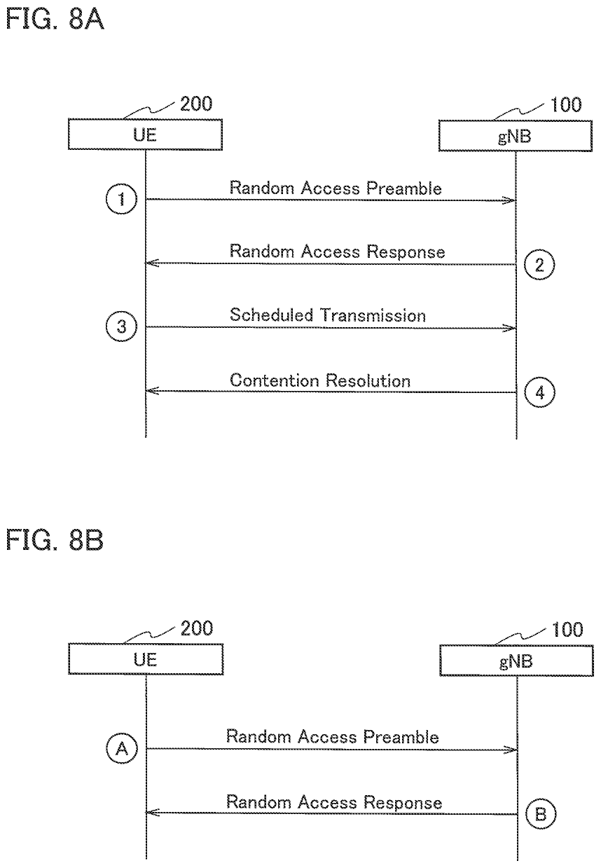

FIGS. 8A and 8B show sequence examples of a random access (RA) procedure. Specifically, FIG. 8A shows a 4-step RA procedure (contention base) sequence, and FIG. 8B shows a 2-step RA procedure.

The RA procedure is triggered by events such as:
Initial access from idle state (RRC_IDLE) of RRC layer
RRC connection re-establishment procedure
Arrival of downlink (DL) or uplink (UL) data in the RRC layer connection state (RRC_CONNECTED) when the uplink synchronization status is “asynchronous”
UL data arrival in RRC_CONNECTED when no PUCCHresource for scheduling request (SR) is available
SR failure
Request by RRC during synchronous reconfiguration (for example, handover)
Transition from RRC layer inactive state (RRC INACTIVE)
Establish time alignment of secondary Timing Advance Group (TAG)
Other SI (System Information) request
Beam failure recovery (BFR)
   As shown in FIG. 8A, the contention-based RA procedure is executed in the order of Random Access Preamble, Random Access Response, Scheduled Transmission, and Contention Resolution. Random Access Preamble, Random Access Response, Scheduled Transmission, and Contention Resolution may be referred to as Msg. 1, 2, 3, 4 respectively. Note that the RA procedure may include contention-free random access (CFRA) in which the sequence starts when the gNB 100 notifies the UE 200 of the Random Access Preamble assignment.

Also, from the physical layer perspective, the RA procedure can include transmission of Random Access Preamble (Msg. 1) in PRACH, Random Access Response (RAR) message with PDCCH/PDSCH (Msg. 2), and when applicable, transmission of PUSCH (Physical Uplink Shared Channel) scheduled by RAR UL grant and transmission of PDSCH (Physical Downlink Shared Channel) for contention resolution.

N number of SS/PBCH Blocks associated with one PRACH Occasion (RO) and R number of contention-based preambles per valid PRACH Occasion (RO) and SS/PBCH Block block are provided to the UE 200 by upper layer signaling, specifically “ssb-perRACH-OccasionAndCB-PreamblesPerSSB”.

The index of SS/PBCH Block provided by ssb-PositionsInBurst of SIB1 or ServingCellConfigCommon is mapped to valid PRACH Occasion (RO) in the following order.

(i) Ascending order of preamble index within one RO
(ii) Ascending order of frequency resource index for frequency multiplexed RO
(iii) Ascending order of time resource index for time multiplexed RO in PRACH slot
The effective RO and preamble index for each SSB is defined by the value of N, the SSB index, N_{preamble}\hat{ }total (which may be expressed as N_{total_preamble}, etc.) that can be set as an integer multiple of N, and the like.

As shown in FIG. 8B, in the two-step RA procedure, Random Access Preamble and Random Access Response are executed in this order. Note that Random Access Preamble and Random Access Response in the two-step RA procedure may be called with different names. Also, Random Access Preamble and Random Access Response in the 2-step RA procedure may be referred to as Msg. A, B, etc., respectively.

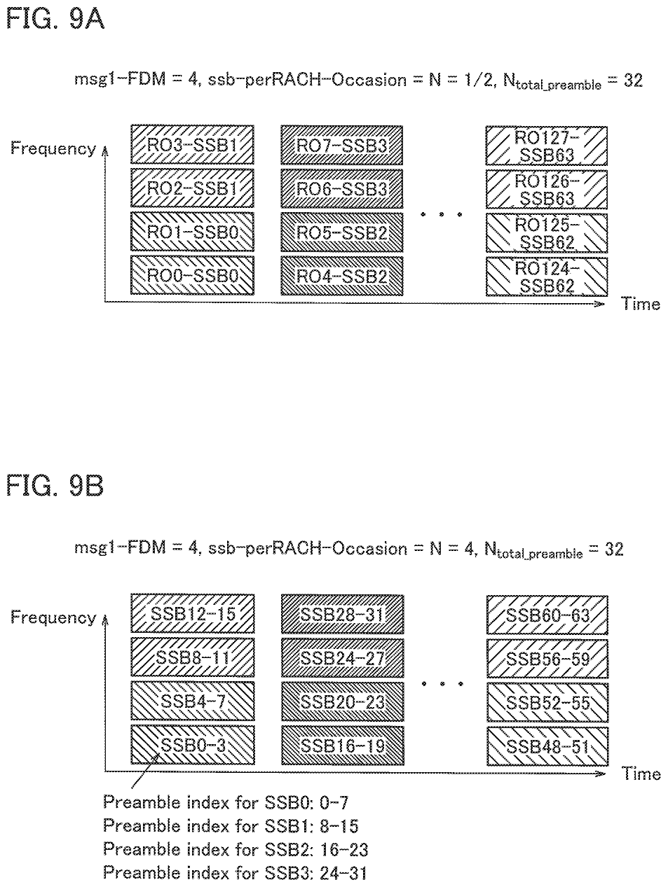

FIG. 9A and FIG. 9B show mapping examples of conventional PRACH Occasion (RO) and SSB index. Specifically, FIG. 9A and FIG. 9B show examples in which a plurality of ROs that is frequency division multiplexed (FDM) is set at one time. FIGS. 9A and 9B are cases where the number of SSBs is 64 (SSB index=1 to 63).

More specifically, FIGS. 9A and 9B both show msg1-FDM=4, that is, an example in which the number of FDMs is set to “4” and N_{preamble}\hat{ }total=32. FIG. 9A shows a case in which ssb-perRACH-Occasion (N)=½, and FIG. 9B shows a case in which ssb-perRACH-Occasion (N)=4.

Therefore, in FIG. 9A, one SSB is mapped to two ROs. For example, SSB0 is mapped to RO0, 1. Subsequent SSBs are similarly mapped to RO.

In this case, R number of contention-based preambles having consecutive indexes associated with SSB (SS/PBCH Block) for each valid RO are used from index 0 of Random Access Preamble (hereinafter abbreviated as “preamble” as appropriate).

In FIG. 9B, four SSBs are mapped to one RO. For example, SSB 0 to 3 are mapped to one RO (corresponding to a square in the drawing). Subsequent SSBs are similarly mapped to RO.

In this case, R number of contention-based preambles having continuous indexes associated with SSB (SS/PBCH Block) for each effective RO are used from the index i*N_{preamble}\hat{ }total/N of the preamble (SSB).

For example, as shown in FIG. 8B, SSB0 to SSB3 and the preamble index are associated as follows.
SSB0 preamble index: 0 to 7
SSB1 preamble index: 8 to 15
SSB2 preamble index: 16 to 23
SSB3 preamble index: 24 to 31

### (2) FUNCTIONAL BLOCK CONFIGURATION OF RADIO COMMUNICATION SYSTEM

Next, a functional block configuration of the radio communication system 10 will be described. Specifically, the functional block configuration of the UE 200 will be described.

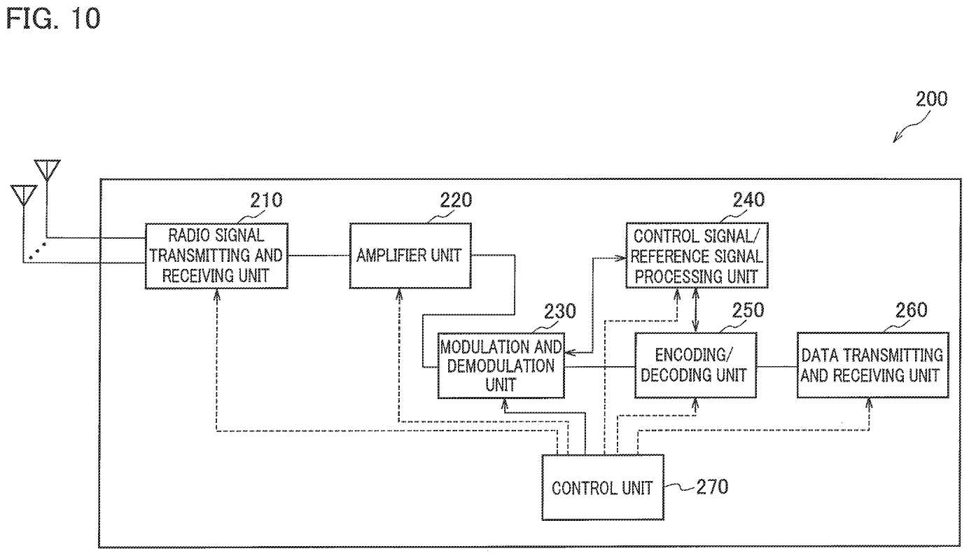

FIG. 10 is a functional block diagram of the UE 200. As shown in FIG. 10, the UE 200 includes a radio signal transmitting and receiving unit 210, an amplifier unit 220, a modulation and demodulation unit 230, a control signal/reference signal processing unit 240, an encoding/decoding unit 250, a data transmitting and receiving unit 260, and a control unit 270.

The radio signal transmitting and receiving unit 210 transmits/receives a radio signal according to NR. The radio signal transmitting and receiving unit 210 corresponds to Massive MIMO, CA that bundles a plurality of CCs, and DC that performs communication simultaneously between the UE and each of the two NG-RAN Nodes.

Further, the radio signal transmitting and receiving unit 210 may transmit/receive a radio signal using a slot having a larger number of symbols than when FR1 or FR2 is used. Note that the number of symbols is specifically the number of OFDM symbols constituting the slot shown in FIG. 3.

For example, the radio signal transmitting and receiving unit 210 can transmit and receive a radio signal by using a slot having a 28 symbol/slot configuration.

In the present embodiment, the radio signal transmitting and receiving unit 210 can receive the synchronization signal block, specifically SSB (SS/PBCH Block), in one or a plurality of frequency ranges, specifically, different frequency bands different from the frequency bands including FR1 and FR2, that is, in FR3 and FR4. In the present embodiment, the radio signal transmitting and receiving unit 210 constitutes a receiving unit.

Specifically, the radio signal transmitting and receiving unit 210 can receive at least one of a plurality of SSBs transmitted from the network by using the same time position or the same frequency position and having different indexes for identifying SSBs.

Note that different indexes for identifying SSBs may be interpreted as different pseudo-colocation (QCL) assumptions. That is, the radio signal transmitting and receiving unit 210 (UE 200) can receive at least one of a plurality of SSBs having different QCL assumptions.

QCL means that, for example, when the characteristics of the channel carrying the symbol on one antenna port can be inferred from the channel carrying the symbol on the other antenna port, the two antenna ports are in the same place in a pseudo manner.

In addition, it can be interpreted that SSBs with the same SSB index are assumed to be QCL, and other SSBs (that is, different SSB indexes) should not be assumed to be QCL. Note that QCL may be referred to as quasi-collocation.

In the present embodiment, the maximum number of SSBs (L) is expanded to 256, and as described later, the network (gNB 100) can transmit a plurality of SSBs in the same time position (may be read as time resource, time domain, and the like), or in the same frequency position (may be read as frequency resource, frequency band, frequency domain, and the like).

The radio signal transmitting and receiving unit 210 can receive at least one of the plurality of SSBs transmitted at the same time position or frequency position (that is, can receive a plurality of SSBs).

As will be described later, a plurality of SSBs transmitted from the network can constitute a plurality of synchronization signal block sets (SSB sets). Further, the plurality of synchronization signal block sets transmitted at the same time position are synchronized with each other in the time direction, and can be transmitted at the same timing.

The radio signal transmitting and receiving unit 210 can receive at least one of a plurality of synchronization signal block sets or receive a plurality of synchronization signal block sets.

Further, the radio signal transmitting and receiving unit 210 can receive SSB with an expanded SSB index range compared to the case where a frequency band including FR1 and FR2 is used.

The amplifier unit 220 includes a Power Amplifier (PA)/Low Noise Amplifier (LNA) or the like. The amplifier unit 220 amplifies the signal output from the modulation and demodulation unit 230 to a predetermined power level. The amplifier unit 220 amplifies the RF signal output from the radio signal transmitting and receiving unit 210.

The modulation and demodulation unit 230 executes data modulation/demodulation, transmission power setting, resource block allocation, and the like for each predetermined communication destination (gNB 100 or other gNB).

As explained above, in the present embodiment, CP-OFDM and DFT-S-OFDM can be applied. In the present embodiment, DFT-S-OFDM can be used not only for uplink (UL) but also for downlink (DL).

The control signal/reference signal processing unit 240 executes processing related to various control signals transmitted/received by the UE 200 and processing related to various reference signals transmitted/received by the UE 200.

Specifically, the control signal/reference signal processing unit 240 receives various control signals transmitted from the gNB 100 via a predetermined control channel, for example, a control signal of the radio resource control layer (RRC). The control signal/reference signal processing unit 240 transmits various control signals to the gNB 100 via a predetermined control channel.

The control signal/reference signal processing unit 240 executes processing by using reference signals (RS) such as demodulation reference signal (DMRS) and phase tracking reference signal (PTRS).

DMRS is a known reference signal (pilot signal) for estimating a fading channel used for data demodulation between a base station specific for a terminal and the terminal. PTRS is a terminal-specific reference signal for the purpose of estimating phase noise which is an issue in the high frequency band.

The reference signal includes, apart from DMRS and PTRS, Channel State Information-Reference Signal (CSI-RS) and Sounding Reference Signal (SRS).

A channel includes a control channel and a data channel. A control channel includes PDCCH (Physical Downlink Control Channel), PUCCH (Physical Uplink Control Channel), RACH (Random Access Channel, Downlink Control Information (DCI) including Random Access Radio Network Temporary Identifier (RA-RNTI)), and Physical Includes Broadcast Channel (PBCH).

A data channel includes PDSCH (Physical Downlink Shared Channel), PUSCH (Physical Downlink Shared Channel), and the like. Data means data transmitted via a data channel.

The encoding/decoding unit 250 executes data division/concatenation and channel coding/decoding for each predetermined communication destination (gNB 100 or other gNB).

Specifically, the encoding/decoding unit 250 divides the data output from the data transmitting and receiving unit 260 into pieces of a predetermined size, and performs channel coding on the pieces of the data. The encoding/decoding unit 250 decodes the data output from the modulation and demodulation unit 230 and connects the decoded data.

The data transmitting and receiving unit 260 transmits and receives Protocol Data Unit (PDU) and Service Data Unit (SDU). Specifically, the data transmitting and receiving unit 260 executes PDU/SDU assembly/disassembly and the like in multiple layers (such as medium access control layer (MAC), radio link control layer (RLC), and packet data convergence protocol layer (PDCP)). The data transmitting and receiving unit 260 performs data error correction and retransmission control based on hybrid ARQ (Hybrid automatic repeat request).

The control unit 270 controls each functional block constituting the UE 200. Particularly, in the present embodiment, the control unit 270 determines a transmission opportunity of the preamble via the PRACH (random access channel) based on the received SSB or SSB set. Specifically, the control unit 270 can determine the PRACH Occasion (RO) based on the SSB or SSB set.

In the present embodiment, the control unit 270 can determine the RO based on the SSB whose SSB index is expanded to 64 or more. As explained above, in the present embodiment, the range of SSB index is 0 to 255.

The control unit 270 can determine RO based on i mod M, where SSB index is i and the number of SSB indexes (that is, the number of SSBs) is M. Note that “based on i mod M” may be applied as it is, or an appropriate coefficient or the like may be added as long as a similar result is obtained.

Moreover, when determining RO based on i mod M, the control unit 270 can determine a preamble assigned to each of a plurality of SSBs transmitted by using the same time position. Specifically, the control unit 270 determines a Random Access Preamble assigned to each of a plurality of SSBs transmitted in the same symbol, slot, subframe, or the like.

More specifically, the control unit 270 determines a Random Access Preamble assigned to each SSB based on N_{preamble}\hat{ }total and the number of SSBs. An example of determining such a Random Access Preamble will be described later.

Also, the control unit 270 can determine a preamble transmission opportunity assigned to each of a plurality of SSBs transmitted using the same time position, that is, PRACH Occasion (RO).

Specifically, the control unit 270 can assign a plurality of SSBs transmitted at the same time to different ROs. An example of such allocation of SSB to RO will be described later.

Also, the control unit 270 can determine to increase or decrease the PRACH Occasion (RO) that is frequency division multiplexed (FDM).

Specifically, the control unit 270 can increase the value of msg1-FDM from the value (1, 2, 4.8) specified in Release 15 (for example, 16, 32 can also be set). Alternatively, the control unit 270 can decrease the value of msg1-FDM from the value (for example, make arrangement such that only 1, 2, 4 can be set).

### (3) OPERATION OF RADIO COMMUNICATION SYSTEM

Next, an operation of the radio communication system 10 will be described. Specifically, an operation relating to transmission of a synchronization signal block (SSB) by the gNB 100 and an operation relating to reception of the synchronization signal block by the UE 200 will be described. Furthermore, the determination operation of PRACH Occasion (RO) (including Random Access Preamble) based on the mapping between SSB and PRACH Occasion (RO) (including Random Access Preamble) by UE 200 will be described.

(3.1) Operation Example 1

In this operation example, the network (gNB 100) can simultaneously transmit a plurality of SSBs. Specifically, the network transmits a synchronization signal block set (SSB set) including a plurality of SSBs at the same position in the time direction or the frequency direction.

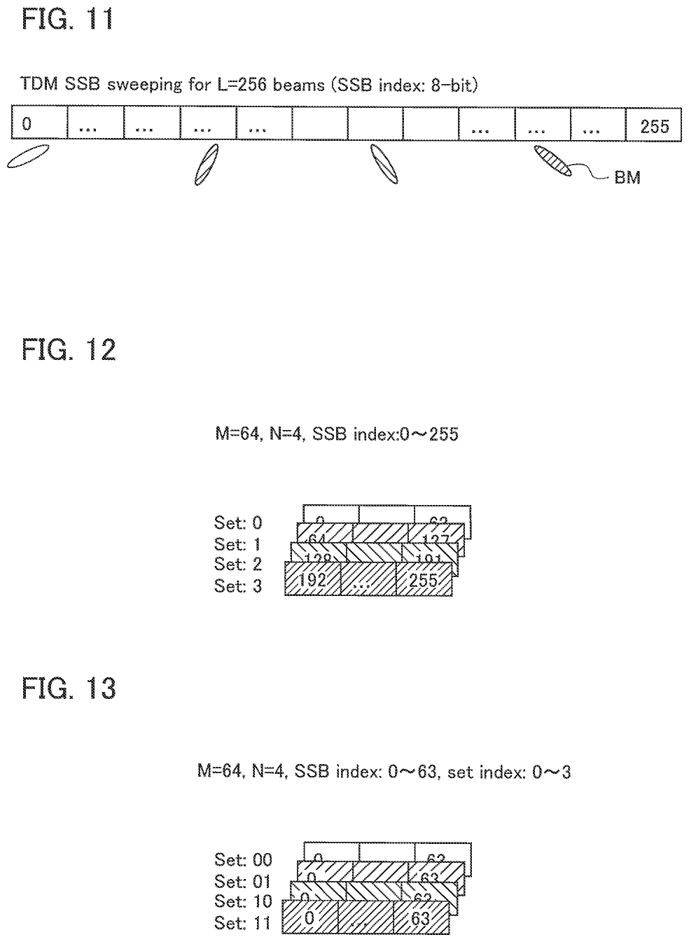

FIG. 11 shows a configuration example of SSB burst when 256 SSBs are transmitted sequentially and not simultaneously. FIG. 12 shows a configuration example of SSB burst when a plurality of SSBs are transmitted simultaneously according to Operation Example 1.

The configuration example shown in FIG. 11 shows a concept in the case of transmitting 256 SSBs, that is, 256 beams BM by time division (TDM) beam sweeping. Among the 256 SSBs, 8 bits (28) are required as the SSB index in order to identify which SSB is detected.

The configuration example shown in FIG. 12 represents a case when the maximum number of SSBs (M) in the SSB set is 64 and the number of SSB sets (N) is 4. Specifically, 0 to 255 may be used for the SSB index, and 0 to 3 may be used for the index of the SSB set.

Thus, the SSBs (maximum number: L) in the SSB burst can be classified into different SSB sets. Note that SSB set may be called by another name such as SSB group.

As shown in FIG. 12, multiple SSBs having different SSB indexes in the SSB set may be transmitted at different positions in the time direction or the frequency direction. A plurality of SSBs included in different SSB sets may be transmitted at the same position in the time direction or the frequency direction.

In the example shown in FIG. 12, SSB set 0 includes SSBs having SSB indexes of 0 to 63. Similarly, SSB set 1 includes SSB with an SSB index of 64 to 127, SSB set 2 includes SSB with an SSB index of 128 to 191, and SSB set 3 includes SSB with an SSB index of 192 to 255. That is, the value of the SSB index included in each SSB set may be different for each SSB set.

For example, SSBs with SSB index=0, 64, 128, 192 can be transmitted at the same position. As shown in FIG. 12, the beam BM associated with the SSB having the SSB index preferably has a different transmission direction so as to cover all directions of the NR cell.

For example, each SSB set is an image corresponding to an antenna panel that forms a beam BM. By using a plurality of antenna panels for transmission of different SSB sets, a plurality of SSBs can be transmitted simultaneously by different beams BM. This operation example can also be applied to analog beam forming as defined in Release 15.

FIG. 13 is a diagram illustrating another configuration example of SSB burst. In the example shown in FIG. 13, the SSB index included in each SSB set (the SSB index of the SSB transmitted at the same time) is common among the SSB sets.

Specifically, when compared with Operation Example 1 and the like, SSB index=0 to 63 is repeated in each SSB set.

On the other hand, 2 bits, specifically, 00, 01, 10, 11 are used as the Set index for identifying the SSB set.

(3.2) Operation Example 2

When using FR2 according to the Release 15 specifications, the mapping from SSB to PRACH Occasion (RO) and the mapping from SSB to Random Access Preamble (preamble) is mainly related to ssb-perRACH-Occasion (related to msg1-FDM and N_{preamble}\hat{ }total).

When SSB index is expanded to 255 as in Operation Example 1, the UE 200 needs to recognize how the PRACH Occasion (RO) (including Random Access Preamble) is mapped.

Hereinafter, some examples of operations in which the UE 200 can correctly recognize the PRACH Occasion (RO) even in such a case will be described.

(3.2.1) Operation Example 2-1

In this operation example, the same mapping as Release 15 is applied to the SSB with SSB index of 64 or more.

Specifically, even when SSB index i=64 (or Set index >0), the mapping of RO and preamble is the same as the mechanism defined in the Release 15 specification. That is, the SSB and the PRACH Occasion (RO) are mapped based on the SSB in which the SSB index is expanded.

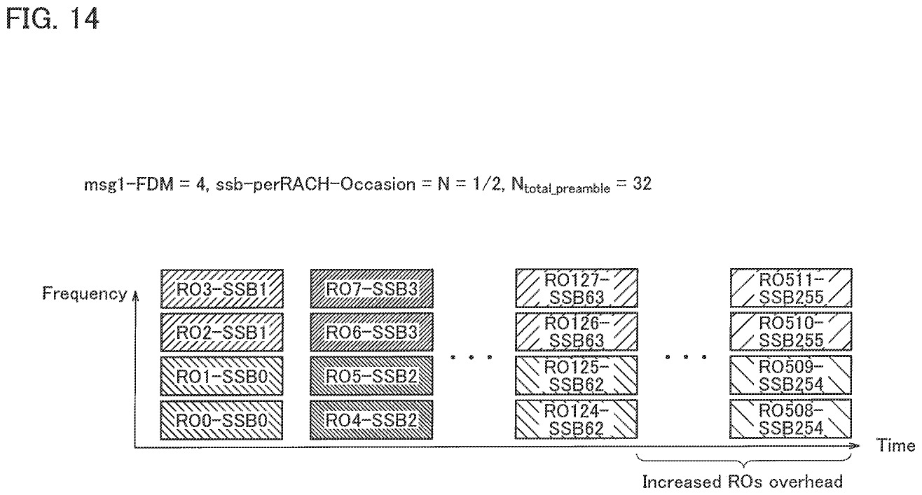

FIG. 14 shows an example of mapping between SSB and RO in Operation Example 2-1. The example shown in FIG. 14 corresponds to msg1-FDM=4, ssb-perRACH-Occasion (N)=½, and N_{preamble}\hat{ }total=32 as in FIG. 9A described above.

As shown in FIG. 14, RO increases as the number of SSB increases. In this operation example, a dedicated RO is mapped to each SSB, which means that the overhead for the RO also increases.

In the case of this operation example, the gNB 100 can recognize which SSB the UE 200 has accessed (that is, received the SSB) by detecting the RO used by the UE 200. For this reason, UE 200 does not need to notify the network of SSB index (specifically, most significant bit (MSB) of SSB index) or Set index.

(3.2.2) Operation Example 2-2

In this operation example, SSBs transmitted at the same time share the same RO, that is, RACHresource. Specifically, when SSB index i≥64 (or Set index >0), RO and preamble mapping is determined based on i mod 64 (or can be expressed as i mod M). “M” means the number of SSB settings included in the SSB set.

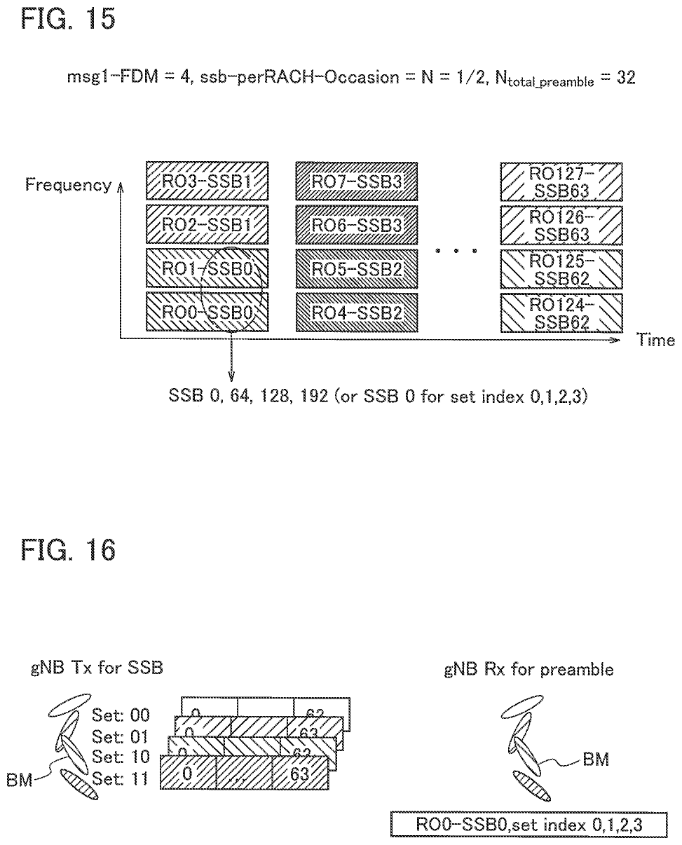

FIG. 15 shows an example of mapping between SSB and RO in Operation Example 2-2. In the example shown in FIG. 15, msg1-FDM=4, ssb-perRACH-Occasion (N)=½, and N_{preamble}\hat{ }total=32 as in FIG. 9A described above.

However, according to i mod 64, SSB 0, 64, 128, 192 (or SSB 0 for Set index 0, 1, 2, 3) is mapped to the same RO.

Thus, in the case of this operation example, transmitted at the same time means that SSBs transmitted using same time position or same frequency position share RACHresource, that is, share RO and preamble.

On the other hand, in the case of this operation example, since a plurality of SSBs share the RACHresource, it may be difficult for the gNB 100 to recognize which SSB the UE 200 has accessed. Specifically, how the gNB 100 recognizes the MSB (or Set index) of the SSB index can be an issue.

Therefore, in order to detect preambles transmitted by ROs associated with a plurality of different SSBs, the gNB 100 may use different reception (RX) beams, antenna panels, or antenna elements.

FIG. 16 shows a concept of transmission/reception of a beam BM by the gNB 100 in Operation Example 2-2. As shown in FIG. 16, because the gNB 100 uses different RX side beam BM, antenna panel, or antenna element in addition to transmitting side (TX) beam BM, it is possible to recognize whether the SSB having the index MSB (or Set index) has been accessed. For this reason, the UE 200 does not need to notify the network of SSB index (or Set index).

For example, if the gNB 100 detects a preamble transmitted from the UE 200 via the beam BM indicated by the leader line, the beam BM selected (that is, transmitted) by the UE 200 is recognized as SSB: 0 of set index: 2 (binary 01).

With such a method, the gNB 100 can implicitly know the SSB selected by the UE 200, but such recognition may not always be sufficient from the viewpoint of reliability.

When the gNB 100 erroneously detects the SSB selected by UE 200, it is unlikely that the UE 200 can correctly decode the RAR.

Therefore, the UE 200 may notify the network of the SSB index (or Set index) of the selected SSB. Specifically, in either the 4-step RA procedure (see FIG. 8A) or the 2-step RA procedure, the UE 200 can notify the SSB index (or Set index).

In the case of the 4-step RA procedure, information on at least a part of the SSB index (for example, MSB or Set index of the SSB index) is notified from the UE 200 to the gNB 100 by Msg. 3, that is, Scheduled Transmission. Information regarding at least a part of the SSB index (eg, MSB or Set index of the SSB index) may be part of the layer 1 report. In addition, notification of information regarding at least a part of the SSB index (for example, the MSB or Set index of the SSB index) may be triggered by Msg. 2, that is, Random Access Response (RAR).

As explained above, when the gNB 100 erroneously detects the SSB selected by the UE 200, because RAR is transmitted to the UE 200 by a beam BM with different QCL assumptions, the chances that the UE 200 may receive (detect) the RAR is low.

In the case of the 2-step RA procedure, information on at least a part of the SSB index (for example, the MSB or Set index of the SSB index) is notified from the UE 200 to the gNB 100 by Msg. A. The gNB 100 determines the Type1-PDCCH CSS set for RAR transmission according to information on at least part of the explicit SSB index (for example, MSB or Set index of the SSB index) from the UE 200 for QCL determination.

The UE 200 assumes that the DM-RS antenna port of CORESET (control resource sets: control resource set) associated with Type1-PDCCH CSS set is QCL state with SSB index and Msg. A payload used for PRACH association.

(3.2.3) Operation Example 2-3

In this operation example, although the processing is performed in accordance with Operation Example 2-2 described above, a preamble is assigned to each of a plurality of SSBs that is simultaneously transmitted.

Specifically, as in Operation Example 2-2, when SSB index i≥64 (or Set index >0), RO and preamble mapping is determined based on i mod 64 (or can be expressed as i mod M).

In this operation example, the preamble is individually assigned to the SSB transmitted at the same time, that is, transmitted using the same time position.

When ssb-perRACH-Occasion (N)<1, a contention-based preamble is allocated according to (Equation 1).

$$( i floor M ) * {N}_{preamble} \hat{} total / S or Set index * {N}_{preamble} \hat{} total / S \qquad ( Equation 1 )$$

Here, “S” means the size of the SSB set, and “i” means the SSB index.

When ssb-perRACH-Occasion (N)≥1, a contention-based preamble is assigned according to (Equation 2).

$$( i floor M ) * {N}_{preamble} \hat{} total / N ( i mod M ) * {N}_{preamble} \hat{} total / ( S * N ) \qquad ( Equation 2 )$$

“M” means, as explained above, the number of SSB settings included in the SSB set.
In the case of this operation example, a plurality of SSBs transmitted at the same time share one or a plurality of ROs but have different preambles.

In the case of this operation example, the UE 200 does not need to notify the network of the MSB or Set index of the SSB index. In the case of this operation example, N_{preamble}\hat{ }total is preferably an integer multiple of S*N.

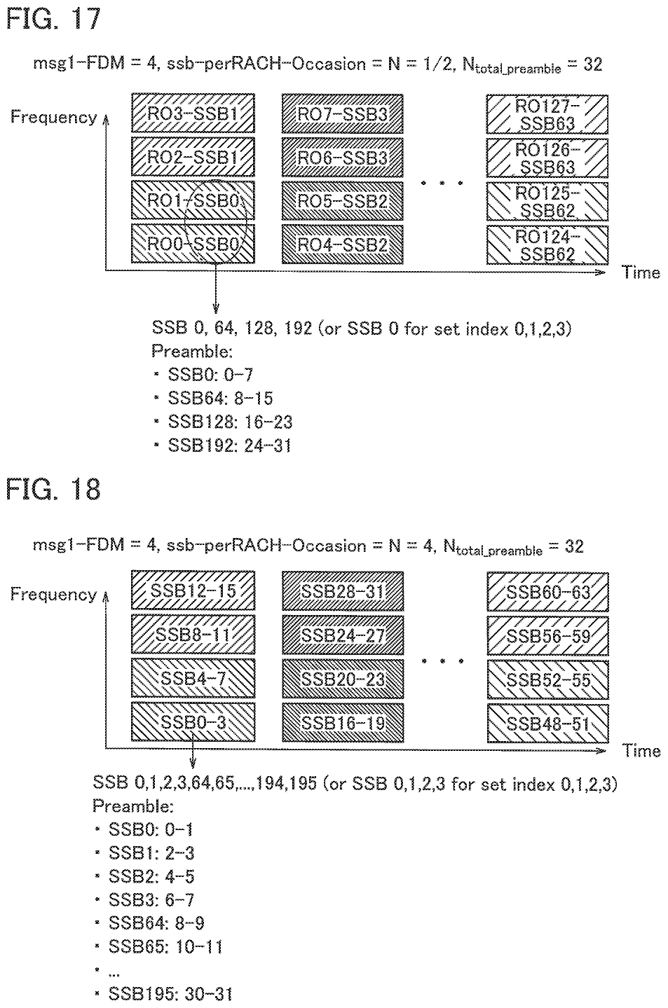

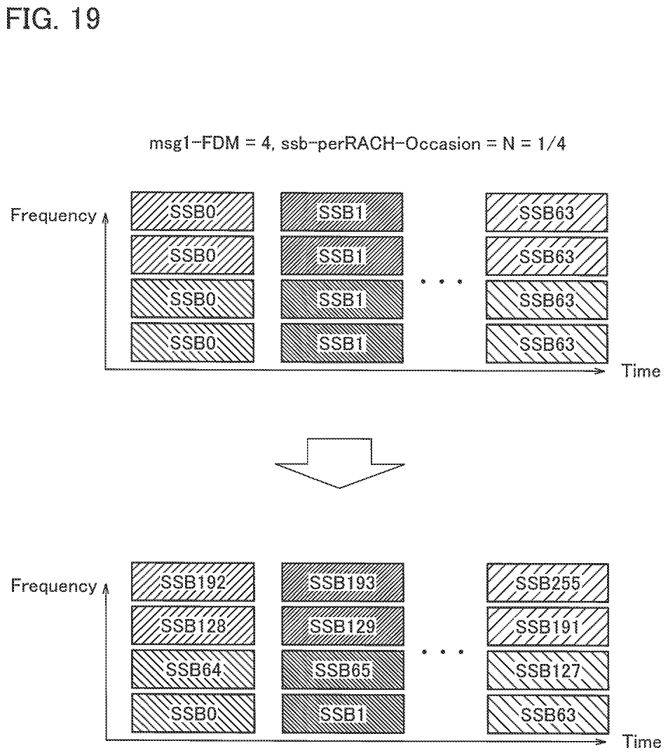

FIGS. 17 and 18 show examples of mapping between SSB and RO in Operation Example 2-3. FIGS. 17 and 18 correspond to FIGS. 9A and 9B, respectively. That is, in the example shown in FIG. 18, as in FIG. 9A, msg1-FDM=4, ssb-perRACH-Occasion (N)=½, and N_{preamble}\hat{ }total=32. In the example shown in FIG. 19, as in FIG. 9B, msg1-FDM=4, ssb-perRACH-Occasion (N)=4, and N_{preamble}\hat{ }total=32.

In the example shown in FIG. 17, that is, when ssb-perRACH-Occasion (N)<1, a preamble is assigned to each of a plurality of SSBs that is simultaneously transmitted according to (Equation 1) described above. For example, as shown in FIG. 17, to SSB 0, 64, 128, 192 (or SSB 0 of Set index 0, 1, 2, 3) are assigned different preamble indexes (similar to FIG. 9B).

In the example shown in FIG. 18, that is, when ssb-perRACH-Occasion (N)≥1, a preamble is assigned to each of a plurality of SSBs transmitted simultaneously according to (Equation 2). For example, as shown in FIG. 18, different preamble indices are assigned to SSB 0, 1, 2, 3, 64, 65, . . . , 194, 195 (or SSB 0, 1, 2, 3 in Set index 0, 1, 2, 3).

(3.2.4) Operation Example 2-4

In this operation example as well, the operation is performed in accordance with Operation Example 2-2 described above, although different FDM PRACH Occasions (RO) are assigned to each of a plurality of SSBs transmitted simultaneously.

Specifically, as in Operation Example 2-2, when SSB index i≥64 (or Set index >0), RO and preamble mapping are determined is based on i mod 64 (or can be expressed as i mod M).

In this operation example, the RO that is FDMed is further allocated to the SSB transmitted at the same time, that is, transmitted using the same time position.

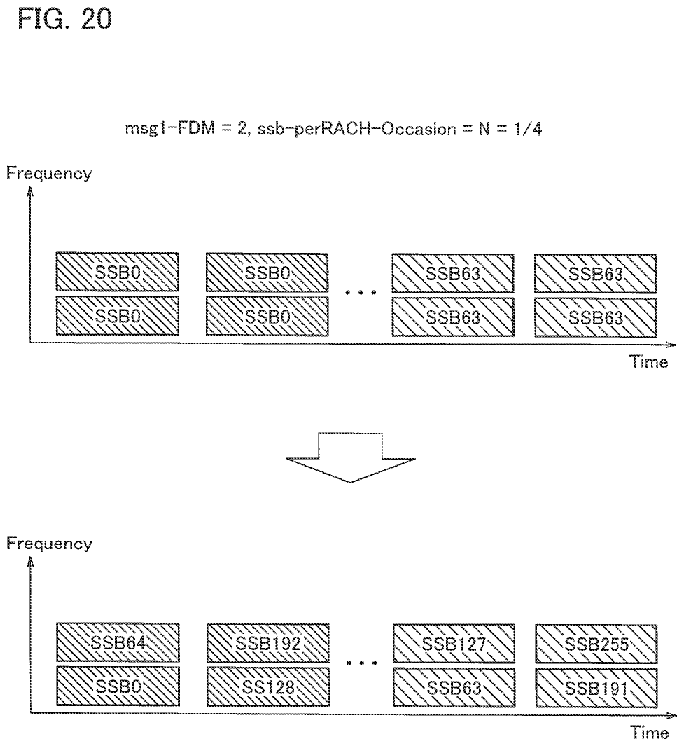

FIGS. 19 and 20 show examples of mapping between SSB and RO in Operation Example 2-4. In the example shown in FIG. 19, msg1-FDM=4 and ssb-perRACH-Occasion (N)=¼. In the example shown in FIG. 20, msg1-FDM=2 and ssb-perRACH-Occasion (N)=¼.

The upper part of FIG. 19 and FIG. 20 shows a conventional mapping example before the RO assignment based on this operation example is applied, and the lower part shows a mapping example to which the RO assignment based on this operation example is applied.

This operation example can be applied when the number of SSB sets ≤1/N (N≤1) is satisfied. This means that simultaneously transmitted SSBs are assigned to different ROs.

As shown in FIGS. 19 and 20, for example, multiple SSBs 0, 64, 128, 192 (see FIG. 12) transmitted using simultaneous transmission, that is, same time position are assigned to different ROs.

(3.2.5) Operation Example 2-5

In this operation example, the settable value of the number of PRACH Occasion (RO) to be frequency division multiplexed (FDM) is added or limited.

Specifically, when using a high frequency band such as FR4, msg1-FDM defining the number of RO FDMs may be expanded. While Release 15 supports {1, 2, 4, 8} as msg1-FDM, in this operation example, for example, it can be expanded so as to set {1, 2, 4, 8, 16, 32}.

On the other hand, when using a high frequency band such as FR4, a value that can be set as msg1-FDM may be limited or deleted, or msg1-FDM may not be supported. Alternatively, the existing value limit of ssb-perRACH-Occasion may be deleted or not supported. Alternatively, the combination of msg1-FDM and ssb-perRACH-Occasion may be restricted.

As explained above, when using a high frequency band such as FR4, the width of the beam BM is considered to be narrow, and therefore, the PRACH capacity that can be supported by each beam BM is considered to be sufficient. For example, in ssb-perRACH-Occasion, a smaller value (for example, ⅛, from {⅛, ¼, ½, 1, 2, 4, 8, 16} specified in Release 15)) may not be supported when using a high frequency band such as FR4.

### (4) ADVANTAGEOUS EFFECTS

According to the above-described embodiment, the following effects can be achieved. Specifically, even when the SSB index is expanded, the UE 200 can determine the PRACH Occasion (RO) associated (mapped) with the SSB based on the SSB with the expanded SSB index.

For this reason, the UE 200 can correctly recognize the PRACH Occasion (RO) mapped to the SSB even when the SSB setting is expanded.

The UE 200 can determine RO based on i mod M, where SSB index is i and the number of SSBs in the SSB set is M. The UE 200 can correctly recognize the RO associated with the SSB even when the number of SSBs increases.

Further, the UE 200 can determine a preamble or RO allocated to each of a plurality of SSBs transmitted simultaneously. For this reason, even when a plurality of SSBs is simultaneously transmitted, the UE 200 can correctly recognize the RO associated with the SSB.

The UE 200 may decide to increase or decrease the frequency division multiplexed (FDM) RO. For this reason, even when the FDM RO is increased or decreased according to the frequency band used (particularly, high frequency band such as FR4), the RO associated with the SSB can be correctly recognized.

### (5) OTHER EMBODIMENTS

Although the contents of the present invention have been described by way of the embodiments, it is obvious to those skilled in the art that the present invention is not limited to what is written here and that various modifications and improvements thereof are possible.

For example, in the above-described embodiment, the mapping between the SSB and the PRACH Occasion (RO) has been described as including the Random Access Preamble mapping. However, it is allowable that only the SSB and the PRACH Occasion (RO) are mapped. Alternatively, only SSB and Random Access Preamble may be mapped.

In the embodiment described above, a high frequency band such as FR4, that is, a frequency band exceeding 52.6 GHz has been described as an example; however, it is allowable that at least one of the above-described operation examples is applied to other frequency ranges such as FR3.

Furthermore, as explained above, FR4 may be divided into a frequency range of 70 GHz or lower and a frequency range of 70 GHz or higher. FR4 can be applied to the frequency range of 70 GHz or higher (Proposal 1) to (Proposal 3), and the correspondence between the proposal and the frequency range may be changed as appropriate, for example, the proposal can be partially applied to the frequency range.

Moreover, the block diagram used for explaining the embodiments (FIG. 10) shows blocks of functional unit. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that causes transmitting may be called a transmitting unit or a transmitter. For any of the above, as explained above, the realization method is not particularly limited to any one method.

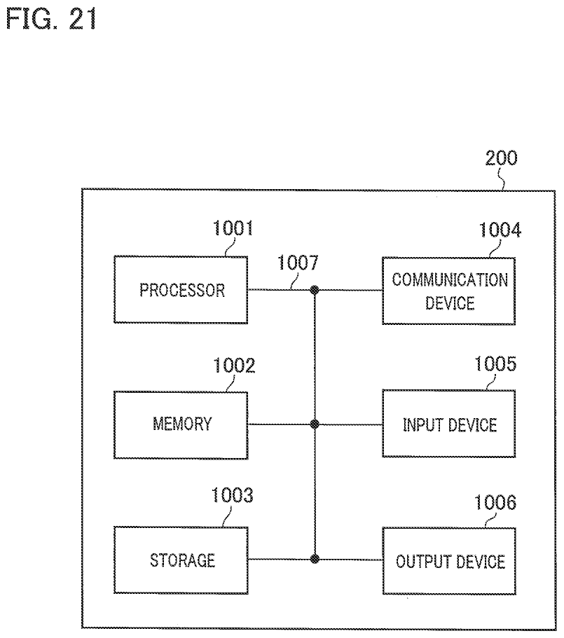

Furthermore, the UE 200 explained above can function as a computer that performs the processing of the radio communication method of the present disclosure. FIG. 21 is a diagram showing an example of a hardware configuration of the UE 200. As shown in FIG. 21, the UE 200 can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

The functional blocks of the UE 200 (see FIG. 10) can be realized by any of hardware elements of the computer device or a desired combination of the hardware elements.

Moreover, the processor 1001 performs computing by loading a predetermined software (computer program) on hardware such as the processor 1001 and the memory 1002, and realizes various functions of the UE 200 by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main memory), and the like. The memory 1002 can store therein a computer program (computer program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information there among. The bus 1007 can be constituted by a single bus or can be constituted by separate buses between the devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB), System Information Block (SIB)), other signals, or a combination of these. The RRC signaling may be called RRC message, for example, or can be RRC Connection Setup message, RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station. A radio frame may be composed of one or more frames in the time domain. Each frame or frames in the time domain may be referred to as a subframe.

A subframe may be further configured by one or more slots in the time domain. The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in a time unit larger than a minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one between a subframe and TTI may be a subframe (1 ms) in existing LTE, or may be shorter than 1 ms (for example, 1 to 13 symbols), or a period longer than 1 ms. Note that, a unit representing TTI may be called a slot, a minislot, or the like instead of a subframe.

Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. Further, the number of slots (the number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the numerology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain numerology in a certain carrier. Here, a common RB may be specified by RB index based on the common reference point of the carrier. PRB may be defined in BWP and numbered within that BWP.

BWP may include UL BWP (UL BWP) and DL BWP (DL BWP). One or a plurality of BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgement” and “decision” may include considering some operation as “judged” and “decided”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system
20 NG-RAN
100 gNB
200 UE
210 Radio signal transmitting and receiving unit
220 Amplifier unit
230 Modulation and demodulation unit
240 Control signal/reference signal processing unit
250 Encoding/decoding unit
260 Data transmitting and receiving unit
270 Control unit
1001 Processor
1002 Memory
1003 Storage
1004 Communication device
1005 Input device
1006 Output device
1007 Bus

1. A terminal comprising:
a receiving unit that receives a synchronization signal block in a different frequency band different from a certain frequency band that includes one or a plurality of frequency ranges; and
a control unit that determines a transmission opportunity of a preamble via a random access channel based on the synchronization signal block, wherein
the receiving unit receives the synchronization signal block in which a range of an index of the synchronization signal block is expanded as compared with the case of using the certain frequency band, and
the control unit determines the transmission opportunity of the preamble based on the synchronization signal block with the index expanded.

2. A terminal comprising:
a receiving unit that receives a synchronization signal block in a different frequency band different from a certain frequency band that includes one or a plurality of frequency ranges; and
a control unit that determines a transmission opportunity of a preamble via a random access channel based on the synchronization signal block, wherein
the receiving unit receives the synchronization signal block in which a range of an index of the synchronization signal block is expanded as compared with the case of using the certain frequency band, and
the control unit determines the transmission opportunity of the preamble via the random access channel based on i mod M, where i is an index of the synchronization signal block and M is number of the synchronization signal blocks.

3. The terminal as claimed in claim 2, wherein the control unit determines a preamble assigned to each of a plurality of synchronization signal blocks transmitted by using same time position.

4. The terminal as claimed in claim 2, wherein the control unit determines the transmission opportunity of a preamble assigned to each of a plurality of synchronization signal blocks transmitted by using same time position.

5. A terminal comprising:
a receiving unit that receives a synchronization signal block in a different frequency band different from a certain frequency band that includes one or a plurality of frequency ranges; and
a control unit that determines a transmission opportunity of a preamble via a random access channel based on the synchronization signal block, wherein
the receiving unit receives the synchronization signal block in which a range of an index of the synchronization signal block is expanded as compared with the case of using the certain frequency band, and
the control unit determines to increase or decrease the transmission opportunity of the preamble that is frequency division multiplexed.
